(19) United States
(12) Patent Application Publication
(10) Pub. No.: US 2024/0086717 A1
(43) Pub. Date: Mar. 14, 2024

(54) MODEL TRAINING CONTROL METHOD BASED ON ASYNCHRONOUS FEDERATED LEARNING, ELECTRONIC DEVICE AND STORAGE MEDIUM

(71) Applicant: Beijing Baidu Netcom Science Technology Co., Ltd., Beijing (CN)

(72) Inventors: Ji LIU, Beijing (CN); Hao TIAN, Beijing (CN); Ruipu ZHOU, Beijing (CN); Dejing DOU, Beijing (CN)

(21) Appl. No.: 18/098,514

(22) Filed: Jan. 18, 2023

(30) Foreign Application Priority Data
Aug. 25, 2022 (CN) 202211025788.2

(51) Int. Cl. G06N 3/098

(52) U.S. Cl. CPC G06N 3/098

(57) ABSTRACT

Disclosed is a model training control method based on asynchronous federated learning, an electronic device and a storage medium, relating to data processing technical field, and especially to technical fields such as edge computing and machine learning. The method includes: sending a first parameter of a first global model to a plurality of edge devices; receiving a second parameter of a second global model returned by a first edge device of plurality of edge devices, the second global model being a global model obtained after the first edge device trains the first global model according to a local data set; and sending a third parameter of a third global model to a second edge device of the plurality of edge devices in a case of the third global model is obtained based on aggregation of at least one second global model.

### CROSS-REFERENCE TO RELATED APPLICATIONS

The present application claims priority to Chinese Patent Application No. CN 202211025788.2, filed with the China National Intellectual Property Administration on Aug. 25, 2022, the disclosure of which is hereby incorporated herein by reference in its entirety.

### TECHNICAL FIELD

The present disclosure relates to the field of data processing technologies, and in particular, to the technical fields such as edge computing and machine learning.

### BACKGROUND

With increment of various edge devices, such as smart phones, Internet of Things devices, mobile sensor devices, more and more data are available for deep learning model training in different artificial intelligence applications. A traditional model training method transmits all data to a server for centralized training, which brings a plurality of problems such as huge communication overhead, limited computing resources and privacy security risks. Federated learning (FL) may effectively solve these problems.

In the federated learning, edge devices are generally responsible for model training and a server is responsible for model aggregation. In order to improve training speed, there is proposed an asynchronous optimization scheme of the federated learning in which the server sends a global model to selected edge devices which use their local data to update the received global model; and the server may perform aggregation of global models after receiving the global model returned by any edge devices without waiting for all the edge devices to complete the local training. Although the asynchronous optimization scheme may prevent the server from waiting for slow-speed edge devices, efficiency and accuracy of model training based on the federated learning still remains to be improved.

### SUMMARY

The present disclosure provides a model training control method, apparatus and system based on asynchronous federated learning.

According to a first aspect of the present disclosure, provided is a model training method based on asynchronous federated learning, including: sending a first parameter of a first global model to a plurality of edge devices, where the first global model is an initial global model; receiving a second parameter of a second global model returned by a first edge device the plurality of edge devices, where the second global model is a global model obtained after the first edge device trains the first global model according to a local data set; and sending a third parameter of a third global model to a second edge device of the plurality of edge devices, in the case where the third global model is obtained based on aggregation of at least one second global model, where the third global model is a latest global model relative to the first global model, and the second edge device is a device which does not complete training on the first global model.

According to a second aspect of the present disclosure, provided is a model training control method based on asynchronous federated learning, which is applied to a second edge device, including: receiving a first parameter of a first global model sent by a base station, where the first global model is an initial model received by the second edge device; determining a fourth global model during training the first global model based on a local data set, in response to receiving a third parameter of a third global model sent by the base station, where the third global model is a latest global model determined by the base station; aggregating the third global model and the fourth global model to obtain a fifth global model; and training the fifth global model based on the local data set to obtain a second global model.

According to a third aspect of the present disclosure, provided is a model training control method based on asynchronous federated learning, including: sending, by a base station, a first parameter of a first global model to a plurality of edge devices, where the first global model is an initial global model; training respectively, by the plurality of edge devices, the first global model based on their respective local data sets; determining, by the base station, a third global model in the case where a second parameter of a second global model returned by a first edge device of the plurality of edge devices is received, where the third global model is a latest global model relative to the first global model; determining, by a second edge device of the plurality of edge devices, a fourth global model during training the first global model, in response to receiving a third parameter of the third global model sent by the base station; aggregating, by the second edge device of the plurality of edge devices, the third global model and the fourth global model to obtain a fifth global model; training, by the second edge device of the plurality of edge devices, the fifth global model based on the local data set to obtain the second global model; and returning, by the second edge device of the plurality of edge devices, the second parameter of the second global model to the base station.

According to a fourth aspect of the present disclosure, provided is a model training control apparatus based on asynchronous federated learning, which is applied to a base station, including: a first sending module configured to send a first parameter of a first global model to a plurality of edge devices, where the first global model is an initial global model; a first receiving module configured to receive a second parameter of a second global model returned by a first edge device of the plurality of edge devices, where the second global model is a global model obtained after the first edge device trains the first global model according to a local data set; and a first control module configured to send a third parameter of a third global model to a second edge device of the plurality of edge devices, in the case where the third global model is obtained based on aggregation of at least one second global mode, where the third global model is a latest global model relative to the first global model, and the second edge device is a device which does not complete training on the first global model.

According to a fifth aspect of the present disclosure, provided is a model training control apparatus based on asynchronous federated learning, which is applied to a second edge device, including: a second receiving module configured to receive a first parameter of a first global model sent by a base station, where the first global model is an initial model received by the second edge device; a third determining module configured to determine a fourth global model during training the first global model based on a local data set, in response to receiving a third parameter of a third global model sent by the base station, where the third global model is a latest global model determined by the base station; a second aggregation module configured to aggregate the third global model and the fourth global model to obtain a fifth global model; and a second control module configured to train the fifth global model based on the local data set to obtain a second global model.

According to a sixth aspect of the present disclosure, provided is a model training control system based on asynchronous federated learning, including: a base station, configured to send a first parameter of a first global model, where the first global model is an initial global model; and a plurality of edge devices, configured to respectively train the first global model based on their respective local data sets. The base station is further configured to determine a third global model in the case where a second parameter of a second global model returned by a first edge device of the plurality of edge devices is received, where the third global model is a latest global model relative to the first global model. A second edge device of the plurality of edge devices is further configured to determine a fourth global model during training the first global model in response to receiving a third parameter of the third global model sent by the base station, aggregate the third global model and the fourth global model to obtain a fifth global model, train the fifth global model based on the local data set to obtain the second global model, and return the second parameter of the second global model to the base station.

According to a seventh aspect of the present disclosure, provided is an electronic device, including: at least one processor; and a memory connected in communication with the at least one processor. The memory stores an instruction executable by the at least one processor, and the instruction, when executed by the at least one processor, enables the at least one processor to execute the method of the first aspect and/or the second aspect and/or the third aspect as set forth above.

According to an eighth aspect of the present disclosure, provided is a non-transitory computer-readable storage medium storing a computer instruction thereon, and the computer instruction is used to cause a computer to execute the method of the first aspect and/or the second aspect and/or the third aspect as set forth above.

According to a ninth aspect of the present disclosure, provided is a computer program product including a computer program, and the computer program implements the method of the first aspect and/or the second aspect and/or the third aspect as set forth above, when executed by a processor.

According to the technical schemes of the present disclosure, efficiency and accuracy of model training can be improved.

The foregoing summary is provided for a purpose of description only and is not intended to be limiting in any way. In addition to exemplary aspects, implementations, and features as described above, further aspects, implementations, and features of the present application will be readily apparent with reference to the accompanying drawings and the following detailed description.

### BRIEF DESCRIPTION OF THE DRAWINGS

In the accompanying drawings, like reference numerals designate like or similar components or elements throughout the accompanying drawings unless otherwise specified. The accompanying drawings are not necessarily drawn to scale. It should be appreciated that the accompanying drawings only depict some implementations disclosed according to the present application, and should not be considered as limiting of the scope of the present application.

FIG. 1 is an architecture diagram of model training control based on asynchronous federated learning according to an embodiment of the present disclosure.

FIG. 2 is a first flowchart diagram of a model training control method based on asynchronous federated learning according to an embodiment of the present disclosure.

FIG. 3 is a second flowchart diagram of a model training control method based on asynchronous federated learning according to an embodiment of the present disclosure.

FIG. 4 is a schematic diagram of a process of changing a first global model to a second global model according to an embodiment of the present disclosure.

FIG. 5 is a third flowchart diagram of a model training control method based on asynchronous federated learning according to an embodiment of the present disclosure.

FIG. 6 is a schematic diagram of a framework of an additional sending model according to an embodiment of the present disclosure.

FIG. 7 is a first schematic diagram of a model training control apparatus based on asynchronous federated learning according to an embodiment of the present disclosure.

FIG. 8 is a second schematic diagram of a model training control apparatus based on asynchronous federated learning according to an embodiment of the present disclosure.

FIG. 9 is a schematic diagram of a model training control system based on asynchronous federated learning according to an embodiment of the present disclosure.

FIG. 10 is a schematic diagram of a scenario of model training control based on asynchronous federated learning according to an embodiment of the present disclosure.

FIG. 11 is a block diagram of an electronic device for implementing a model training control method based on asynchronous federated learning according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for the sake of clarity and conciseness, descriptions of well-known functions and structures are omitted in the following descriptions.

The terms “first”, “second”, and “third”, etc. in the embodiments in the descriptions and claims of the present disclosure and the above-described drawings are intended to distinguish similar elements and not necessarily to describe a particular sequential or chronological order. Furthermore, the terms “comprises/includes” and “comprising/including”, as well as any variations thereof, are intended to cover a non-exclusive inclusion, for example, a series of steps or elements is included. The methods, systems, articles, or devices are not necessarily limited to the explicitly listed steps or elements, but may include other steps or elements not expressly listed or inherent to such processes, methods, articles, or devices.

Federated learning may well solve problems of security and privacy, limited computing resources of edge nodes, communication overhead and the like in the field of edge computing. For the federated learning in the field of edge computing, there are two federal optimization schemes, which are a synchronous communication scheme and an asynchronous communication scheme. In synchronous training, a server sends a global model to some selected edge devices, which use their local data to update the received global model; the server waits for updated global models returned by the selected devices and aggregates the updated global models to obtain a new global model. However, most of the edge devices have limited computational resources and communication capabilities, such as low battery power, limited computational power, and network congestion. Training and uploading the model in synchronous optimization may consume a long period of time, and thus an entire training process of the federal learning is inefficient. Furthermore, the synchronous federal optimization fails to take full advantage of idle time of the edge devices for model training. For example, idle devices that are not selected are not utilized during each global iteration, or some devices are idle after uploading the updated local model and may not be selected again. By contrast, in the asynchronous scheme, the server may update the global model immediately upon receiving an updated global model of any of the selected devices without waiting for all the devices to complete local training. Although asynchronous optimization prevents the server from waiting for slow-speed devices, it still cannot take full advantage of idle edge devices. Moreover, the federated learning also faces a problem of non-independently synchronizing and distributing data, whether the synchronous optimization or the asynchronous optimization is adopted.

An edge computing system is used to perform a federated learning task. The edge computing system consists of a base station (BS) and M edge devices. It is assumed that geographic locations of the edge devices and the base station are constant throughout the federated learning. Idle time of a device is defined as a period of time when the device has sufficient power without other local tasks. Each device uses its local data set to train the global model. A set consisting of the M edge devices is denoted as [symbol] ={1,2, . . . , M}, and the local data set owned by each edge device i is denoted as: [symbol] ᵢ={x_{i,d∈} [symbol] ^{s}, y_{id} ∈ [symbol] }_{d=1}^{D}^{ᵢ}; where Dᵢ=| [symbol] ᵢ| is a quantity of samples in the local data set, x_{i,d} is the dth sample at the ith device, the samples are vectors of dimension s, y_{i,d} is a label of x_{i,d}, an entire data set of the whole system is denoted as

$$𝒟 = {⋃}_{i ∈ ℳ} {𝒟}_{i} ,$$

and a total amount of data is denoted as

$$D = {\sum }_{i ∈ ℳ} {D}_{i} .$$

An overall optimization objective is to train a weight w of the global model of the federated learning using the local data [symbol] from all the edge devices to minimize a value of a certain loss function for the weight w, and the optimization objective is defined as:

$${min}_{w} \{ ℱ ( w ) {=}^{Δ} \frac{1}{D} {\sum }_{i ∈ ℳ} {D}_{i} {F}_{i} ( w ) \} ;$$

where [symbol] ᵢ(w) is a local loss function of the ith device, and satisfies:

$${ℱ}_{i} ( w ) {=}^{Δ} \frac{1}{{D}_{i}} {\sum }_{\{ {x}_{i , d} , {y}_{i , d} \} ∈ {D}_{i}} ℱ ( w , {x}_{i , d} , {y}_{i , d} ) ;$$

where F(w, x_{i,d}, y_{i,d}) is a loss of the w at the ith device for the kth round, and defined as: F(w, x_{i,d}, y_{i,d})=f(w; x_{i,d}, y_{i,d})+μ/2 ∥wₖ−w_{i,k}∥²; where f(w; x_{i,d}, y_{i,d}) is a function that measures a loss of the w on a data sample (x_{i,d}, y_{i,d}) at the ith the device. Common loss functions include a cross-entropy loss function, a zero-one loss function, and the like. Here μ is a canonical parameter. The canonical term is used to control a difference between the local model w_{i,k} and the global model wₖ not to be too large.

As an implementation, the edge computing system may employ a synchronous federated learning framework (FedAvg) to perform the federated learning task.

The federated learning solves the above problems in an iterative manner, with the kth round including the following steps.

The base station randomly selects some devices and sends the current global model wₖ₋1.

After each device, that is the ith device, receives the wₖ₋₁, w_{i,k}(0)=wₖ₋₁ is set and then a stochastic gradient descent (SGD) algorithm is applied to its local data set [symbol] ᵢ to calculate the local model w_{i,k}: w_{i,k}(j+1)=w_{i,k}(j)−ηFᵢ(w_{i,k}(j)), j=0,1, . . . , τ−1, where η is a learning rate, ∇Fᵢ(w_{i,k}(j)) is a gradient calculated on a data set of a mini_batch randomly selected from [symbol] ᵢ, a size of the batch is noted as b, τ is the number of local iterations, and both τ and b are fixed system parameters. After τ iterations, w_{i,k}(τ) is uploaded to the base station.

After receiving the global models w_{i,k} uploaded by all the devices in this round, the base station aggregates the global models w_{i,k}, usually by weight-averaging according to the size of the data set of each device:

$${w}_{k} = \frac{{\sum }_{i ∈ {Π}_{k}} {D}_{i} {w}_{i , k}}{{\sum }_{i ∈ {Π}_{k}} {D}_{i} k} .$$

Then the wₖ is uploaded to the base station.

After obtaining the new global model, the base station continues to repeat the above processes and starts the (k+1)th round of training until a satisfactory global model w_{K} is obtained.

As another implementation, the edge computing system may employ an asynchronous federated learning framework (FedAvg) to perform the federated learning task.

The asynchronous federated learning is to change transmission of the model weight among the devices into an asynchronous communication mode, such that the aggregation of the models does not need to wait for the uploading of other devices. The device immediately uploads the model after completing the training, and the base station aggregates the models immediately after receiving them.

Illustratively, an execution process of the asynchronous federated optimization algorithm (FedAsync) includes the following steps.

The base station randomly initializes an initial global model weight, then asynchronously starts the following two processes.

A Scheduler triggers a new device to participate in training at intervals, and transmits a latest global model weight to the triggered device.

An updater continuously receives the local model weight uploaded by the device and aggregates it with the latest global model weight according to a formula, i.e., generates a new global model weight.

A worker in the device continuously waits for the triggering of the base station. Once the device is triggered, the worker receives the latest global model weight, then iteratively updates the model weight on the local data set, and sends a latest local model weight to the base station.

The above operations are all performed asynchronously, and do not have a chronological order. For this reason, the asynchronous processing mode is usually faster than the synchronous processing mode in the aspect of time, but the asynchronous processing mode also has other problems, such as model obsolescence. Here, the obsolescence means that obsolescence of the model on the device makes it is difficult to further increase convergence speed.

In order to at least partially solve one or more of the above problems and other potential problems, the present disclosure provides a model training control method based on asynchronous federated learning, which can improve efficiency and accuracy of the model training based on the federated learning by asynchronously sending an additional global model to an edge device.

In order to improve training efficiency and model accuracy of the federated learning, the present disclosure provides an asynchronous federated learning with additional model downloading (FedAMD) scheme. A key idea of the FedAMD is to asynchronously send the additional global model to the edge device, and the edge device aggregates its local model weight and the latest model weight during the training so as to achieve an effect of improving the accuracy and the convergence speed. Compared with a traditional asynchronous federated learning scheme, the FedAMD enables the edge device to obtain the latest model weight as early as possible, such that information circulation speed is increased while total time consumption is not increased. This is why the FedAMD converges more quickly and has higher accuracy compared with the traditional asynchronous federated learning scheme.

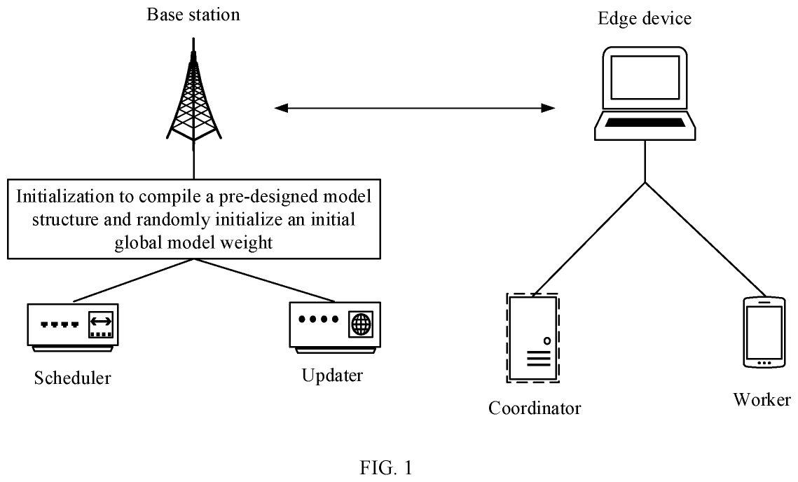

FIG. 1 is an architecture diagram of model training control based on asynchronous federated learning. As shown in FIG. 1, an edge device may receive a latest global model from a base station during training. After receiving the latest global model, the edge device may aggregate the global model during the training, then continue local training on a new model, and immediately upload to the base station after the edge device finishes the training. The architecture includes the base station including a scheduler and an updater, and the edge device including a coordinator and a worker.

Specifically, a processing flow of the base station is as follows.

Firstly, the base station performs initialization, to compile a pre-designed model structure and randomly initialize an initial global model weight.

Then, the base station asynchronously starts following two processes.

The Scheduler triggers a new device to participate in training at intervals, and transmits a latest global model weight to the triggered device.

The Updater continuously receives a local model weight uploaded by the device and aggregates it with the latest global model weight according to a formula, i.e., generates a new global model weight. Once the new global model weight is generated, it is immediately broadcasted to all devices being trained.

Specifically, a processing flow of the edge device is as follows.

The Coordinator continuously waits for the global model weight additionally sent by the base station, immediately terminates updating of a local model by the Worker once the global model weight is received, aggregates the received global model weight and a latest local model weight, and then informs the Worker to continuously complete the following training on the aggregated model weight.

The Worker continuously waits for the triggering of the base station, receives the latest global model weight once the edge device is triggered, then iteratively updates the model weight on a local data set, and sends the latest local model weight to the base station.

The above operations are also performed asynchronously, and do not have a chronological order. Since the base station usually has a larger network bandwidth, time consumption caused by the additional sending may be substantially ignored. Further, compared with FedAsync, the FedAMD consumes the substantially same amount of time. However, due to the additional sending of the model weight, an influence caused by obsolescence is weaken, and the convergence speed and the accuracy can be improved.

The model referred to in the present disclosure may be an image processing model, or an object recognition model. The image processing model includes, but is not limited to, an image annotation model, an image classification model, and the like. The foregoing is merely exemplary and is not intended as a limitation on all possible types of models that may be included but are not exhaustive.

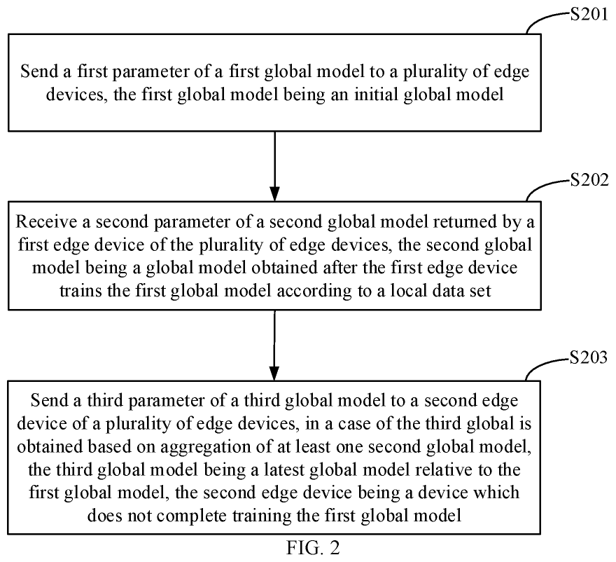

An embodiment of the present disclosure provides a model training control method based on asynchronous federated learning. FIG. 2 is a flowchart diagram of the model training control method based on asynchronous federated learning according to the embodiment of the disclosure, which is applied to the base station in an edge computing system. In some possible implementations, the model training control method based on asynchronous federated learning may also be implemented by a processor invoking computer-readable instructions stored in a memory. As shown in FIG. 2, the model training control method based on asynchronous federated learning includes the followings steps.

In S201, a first parameter of a first global model is sent to a plurality of edge devices, and the first global model is an initial global model.

In S202, a second parameter of a second global model returned by a first edge device of the plurality of edge devices is received, and the second global model is a global model obtained after the first edge device trains the first global model according to a local data set.

In S203, a third parameter of a third global model is sent to a second edge device of the plurality of edge devices, in the case where the third global model is obtained based on aggregation of at least one second global model, the third global model is a latest global model relative to the first global model, and the second edge device is a device which does not complete training the first global model.

In the embodiment of the present disclosure, the first edge device is a device that completes a current round of a training task.

In the embodiment of the present disclosure, the second edge device is a device that does not complete the current round of the training task.

In the embodiment of the present disclosure, the first parameter includes a weight parameter of the first global model. Further, the first parameter may also include a version number of the sent first global model. The above is merely an exemplary illustration and is not intended to be a limitation of all possible parameters that are included in the first parameter but are not exhaustive herein.

In the embodiment of the present disclosure, the second parameter includes a weight parameter of the second global model. Further, the second parameter may also include a version number of a global model used by the device for training. The above is merely an exemplary illustration, and is not intended to be a limitation of all possible parameters that are included in the second parameter but are not exhaustive herein.

In the embodiment of the present disclosure, in the case where the third global model is obtained based on the aggregation of the at least one second global model, the third parameter of the third global model may also be returned to the first edge device, such that the first edge device trains the third global model. As such, the first edge device does not need to wait for the second edge device to complete the training on the first global model after its completion of the training on the first global model. By returning the third parameter of the third global model to the first edge device, it is possible to avoid the first edge device being in an idle state while making full use of computing power of the first edge device, such that the first edge device is allowed to train the third global model to improve an overall model training efficiency.

According to the technical scheme of the embodiment of the present disclosure, compared with a training mode of sending the third parameter of the third global model to the second edge device after the second edge device returns the second parameter of the second global model, the third parameter of the third global model is timely sent to the second edge device such that the second edge device can acquire the latest global model and perform the training in combination with the latest global model, thereby effectively reducing the influence caused by the obsolescence, relieving a problem of low training accuracy caused by obsolescence of a model parameter on a device side, fully utilizing processing speed of the first edge device, increasing model updating speed, and improving the overall model training efficiency.

In some embodiments, the method as described above further includes determining an edge device of the plurality of edge devices that does not return the second parameter of the second global model as the second edge device.

In this way, by determining all edge devices that have not returned the second parameter of the second global model of the plurality of edge devices as second edge devices and sending the third parameter of the third global model to the second edge devices, model training accuracy on sides of all the second edge devices can be improved, thereby improving overall model training accuracy.

In some embodiments, the method as described above further includes determining an edge device of the plurality of edge devices that has not return the second parameter of the second global model and sends a model request as the second edge device, where the model request is used to request for the third global model.

In this way, by determining the edge device that has not returned the second global model and sent the model request as the second edge device and then returning the third parameter of the third global model to the second edge device, the latest model parameter can be sent according to a requirement of the second edge device, thereby improving the training accuracy of the model on sides of some second edge devices, and improving the overall model training accuracy.

In some embodiments, obtaining the third global model based on the aggregation of the second global model includes: aggregating the first global model and second global models whose second parameters have been received to obtain the third global model, in response to detecting that a quantity of the second global models reaches a preset threshold.

In the embodiment of the present disclosure, the preset threshold may be set or adjusted according to a requirement, such as a speed requirement or an accuracy requirement.

In some embodiments, if a quantity of the second global models in M edge devices reaches N and a value of N/M is greater than a certain threshold, the aggregation is performed, where N is less than M.

In some embodiments, if the quantity of the second global models in the M edge devices reaches N and time for the base station to update a weight is reached, the aggregation is performed, where N is less than M.

Therefore, the third global model can be generated at a proper time, and control capability of speed and accuracy of the model training on a side of the base station is improved.

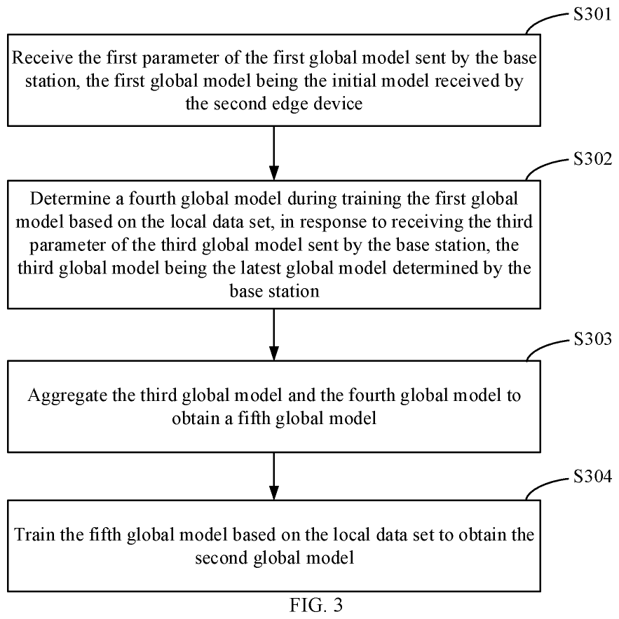

The embodiment of the present disclosure provides a model training control method based on asynchronous federated learning. FIG. 3 is a flowchart diagram of the model training control method based on asynchronous federated learning according to the embodiment of the present disclosure, which is applied to the second edge device in the edge computing system. In some possible implementations, the model training control method based on asynchronous federated learning may also be implemented by a processor invoking computer-readable instructions stored in a memory. As shown in FIG. 3, the model training control method based on asynchronous federated learning includes the following steps.

In S301, the first parameter of the first global model sent by the base station is received, and the first global model is the initial model received by the second edge device.

In S302, a fourth global model is determined during training the first global model based on the local data set, in response to receiving the third parameter of the third global model sent by the base station, and the third global model is the latest global model determined by the base station.

In S303, the third global model and the fourth global model are aggregated to obtain a fifth global model.

In S304, the fifth global model is trained based on the local data set to obtain the second global model.

In the embodiment of the present disclosure, after S304, the method further includes returning, by the second edge device, the second parameter of the second global model to the base station.

In the embodiment of the present disclosure, the second edge device also receives the third parameter of the third global model sent by the base station after receiving the first parameter of the first global model and before returning the second parameter of the second global model to the base station.

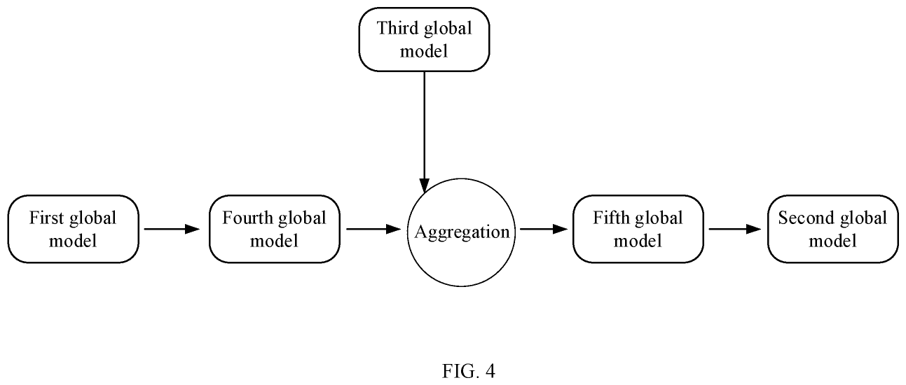

FIG. 4 is a schematic diagram illustrating a process of changing the first global model to the second global model. As shown in FIG. 4, the second edge device initially receives the first parameter of the first global model, and the first global model is changed into the fourth global model during the local training; and the second edge device receives the third parameter of the third global model sent by the base station, aggregates the third global model and the fourth global model into the fifth global model, and then trains the fifth global model into the second global model. It should be noted that, in the process of changing the first global model to the second global model, the fourth global model is a model generated before the third global model is received, and the fifth global model is a model generated according to the third global model and the fourth global model. In the process of changing the first global model to the second global model, the third global model may be received for multiple times, and a quantity of each of the fourth global model and the fifth global model is as much as that of the third global model.

It should be understood that the schematic diagram as shown in FIG. 4 is merely exemplary and not restrictive, and is extensible. Various obvious changes and/or substitutions may be made by those skilled in the art based on the example of FIG. 4, and the resulting technical solutions still fall within the scope of the embodiments of the present disclosure.

According to the technical scheme of the embodiment of the present disclosure, compared with a training mode in which the second edge device acquires the third global model after returning the second global model, the second edge device timely acquires the latest global model and trains in combination with the latest global model, thereby effectively reducing the influence caused by the obsolescence of the model parameter on the device side, relieving the problem of low training accuracy caused by the obsolescence of the model parameter on the device side, improving the accuracy of the second parameter of the second global model returned to the base station by the second edge device, and improving the whole model training efficiency.

In some embodiments, the method further includes sending the model request to the base station during the training on the first global model based on the local data set, the model request is used to request for the third global model.

As such, the second edge device may actively send the model request to the base station according to the requirement. The time for sending the model request may be conveniently determined according to a training condition, thereby improving autonomy of the second edge device.

In some embodiments, the method further includes passively receiving the third parameter of the third global model sent by the base station during the training on the first global model based on the local data set.

As such, the second edge device passively receives the third parameter of the third global model sent by the base station and will not ignore the third parameter of the third global model sent by the base station, thereby effectively reducing obsolescence of the model parameter of the second edge device, and improving accuracy of the second global model trained by the second edge device.

In some embodiments, determining the fourth global model includes determining a latest model obtained from the current training of the second edge device as the fourth global model. The fourth global model is a global model obtained before the training is completed.

In some implementations, it is assumed that a model A and a model B are both models generated by the second edge device during the training based on the first global model, if the second edge device receives the third parameter of the third global model after the model A is obtained by training and before the next global model B of the model A is obtained by training, the model A will be determined as the fourth global model.

In other implementations, it is assumed that a model C is a model generated by the second edge device during the training based on the first global model, if the second edge device receives the third parameter of the third global model during the training for obtaining the model C, the model C will be determined as the fourth global model after the training of the model C is completed.

As such, the latest model obtained from the current training of the second edge device is aggregated with the third parameter of the third global model sent by the base station, thereby effectively reducing the influence caused by the obsolescence of the model parameter of the second edge device, and improving the accuracy of the second global model trained by the second edge device.

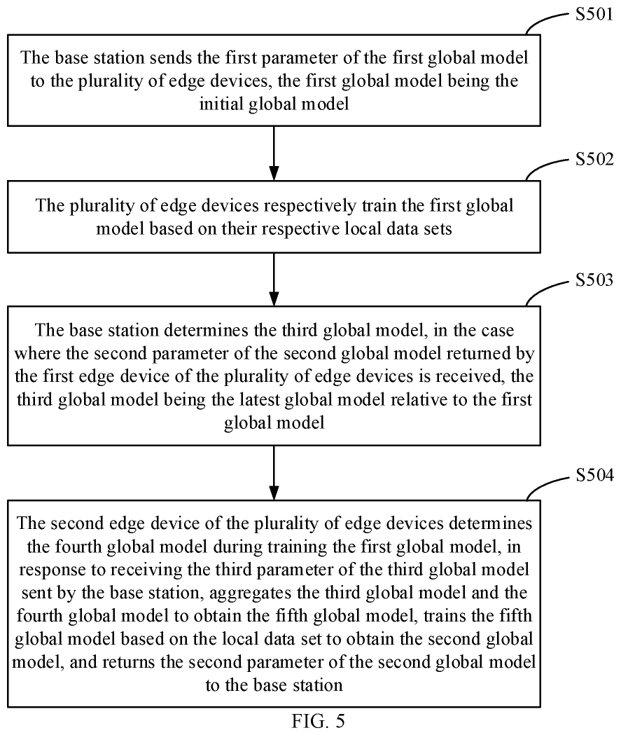

The embodiment of the present disclosure provides a model training control method based on asynchronous federated learning. FIG. 5 is a flowchart diagram of the model training control method based on asynchronous federated learning according to the embodiment of the present disclosure, which is applied to the edge computing system. In some possible implementations, the model training control method based on asynchronous federated learning may also be implemented by a processor invoking computer-readable instructions stored in a memory. As shown in FIG. 5, the model training control method based on asynchronous federated learning includes the following steps.

In S501, the base station sends the first parameter of the first global model to the plurality of edge devices, and the first global model is the initial global model.

In S502, the plurality of edge devices respectively train the first global model based on their respective local data sets.

In S503, the base station determines the third global model, in the case where the second parameter of the second global model returned by the first edge device of the plurality of edge devices is received, and the third global model is the latest global model relative to the first global model.

In S504, the second edge device of the plurality of edge devices determines the fourth global model during training the first global model, in response to receiving the third parameter of the third global model sent by the base station, aggregates the third global model and the fourth global model to obtain the fifth global model, trains the fifth global model based on the local data set to obtain the second global model, and returns the second parameter of the second global model to the base station.

According to the technical scheme of the embodiment of the present disclosure, the base station timely sends the third parameter of the third global model to the second edge device such that the second edge device can acquire the latest global model and perform the training in combination with the latest global model, thereby solving the problem of low training accuracy caused by the obsolescence of the model parameter on the device side, fully utilizing the processing speed of the first edge device, increasing the model updating speed, and improving the overall model training efficiency.

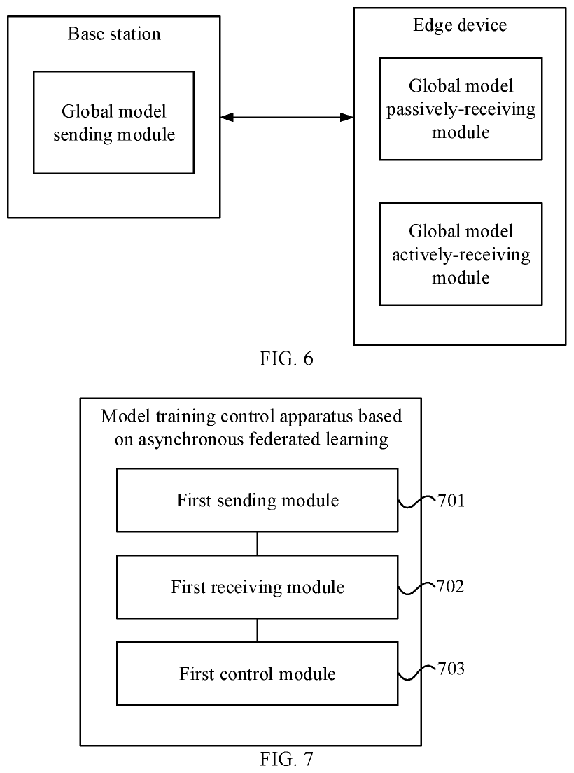

In consideration of actual network conditions and application scenarios, where for example the edge device uses a wired or wireless network for communication, the present disclosure provides two specific communication protocols, which are passive receiving of the additionally sent global model by the edge device and active request for the additionally sent global model by the edge device. FIG. 6 is a schematic diagram of a framework of the additionally sent model. As shown in FIG. 6, the framework includes a global model sending module at the base station, and a global model passively-receiving module and a global model actively-receiving module at the device side. It should be noted that, the M edge devices in the edge computing system may all select the passive receiving of the global model, may all select the active request of the global model, or may partially select the passive receiving of the global model and partially select the active request of the global model.

a) The global model sending module

In the federated learning, the base station usually has larger downlink bandwidth and larger power, and thus cost of additional sending of the global model is lower. Based on this, the inventor improves the traditional asynchronous federated learning to add a step of additionally sending the global model. In addition, since the model is updated quickly, the influence on model training caused by the obsolescence of the model on the edge device side may be effectively relieved by sending of a new model.

b) The global model passively-receiving module

On the basis of FedAsync, a step of sending the global model is added, which is simple to implement and is effective. Consumption of the step is acceptable in a scene of sufficient downlink bandwidth, thus there is no doubt it is worth obtaining extra time saving and precision improvement in return.

An algorithm 1 describes an algorithm that the device passively receives the global model. When the device runs the algorithm, all that the base station needs to do is to immediately broadcast a new global mode to all the devices being trained every time the new global model appears.

The algorithm 1 has an input that is the global model for the current round and an output that is the local model updated for τ iterations. The remaining parameters are system parameters.

Pseudo codes of algorithm 1 may be described with reference to:

Input:

| | |
|---|---|
| i: | device number, i ∈ [symbol] |
| wₖ: | current global model weights |
| k: | current global epoch |
| τ: | The number of local iterations |
| β: | device aggregation weight |
| b: | parameter for calculating adaptive |

Output:

| | |
|---|---|
| w_{i,k}: | updated local model weights in device i |
| κ: | the global epochs when device i starts training |
| 1: | receive the latest global model weights (wₖ^{new}, k^{new}) asynchronously in parallel. |
| 2: | w_{i,k} (0) ← wₖ |
| 3: | for j ∈ [τ] do |
| 4: | if received (wₖ^{new}, k^{new}) then |
| 5: | βₖ ← β × (k − κ + 1)^{-b} |
| 6: | Update w_{i,k}(j) ← (1 − βₖ)w_{i,k}(j) + βₖwₖ^{new} |
| 7: | $Update κ ← \frac{{j}_{k} + ( τ - j ) {k}_{n e w}}{τ}$ |
| 8: | end if |
| 9: | Randomly sample x_{i,d}, y_{i,d} ~ Dⁱ |
| 10: | Update w_{i,k}(j + 1) ~ w_{i,k}(j) − η∇F_{i,w}_{ₖ}(w_{i,k(j)}, X_{i,d}) |
| 11: | end for |
| 12: | w_{i,k} ← w_{i,k} (τ) |
| 13: | return w_{i,k}, κ |

Hereinafter, the pseudo codes of algorithm 1 will be explained.

Line 1: during the local training of the device, the latest global model sent by the base station is asynchronously received.

The operation of asynchronously receiving the latest global model is in parallel with the following operations without a chronological order.

Line 2: the device assigns w_{i,k} (0) as the global model weight wₖ of the current round sent by the base station.

Lines 3-11: τ iterations are performed. Before each iteration, lines 4-8 first judge whether the new global model weight is sent, and if there is, then line 5 first calculates βₖ using b and β, which is the local aggregation weight in line 6. Then, line 7 updates κ according to timing of sending the new global model weight, i.e., j, which will be eventually uploaded to the base station along with the trained local model weight to characterize how far behind the device is. Line 9 reads the local data of the device. Line 10 executes a gradient descent operation to update the local model weight.

Line 12: the local training is completed after the τ iterations, and the local model subjected to the τ iterations is assigned to a variable to be transmitted to the base station.

Line 13: the trained local model weight is outputted.

By the algorithm 1, the problem of the obsolescence of the device in FedAsync can be solved. The edge device passively receives the additionally sent global model, and which is simple in design and easy to implement.

c) The global model actively-requesting module

The passive receiving manner may have problems of obsolescent models and large network bandwidth occupation, for example. For this reason, the inventor also provides a manner that the device actively requests the global model to reduce the occupation of the network bandwidth. Except that there is need to send an additional request, the occupation of the network bandwidth is significantly reduced compared to the passive receiving by the device.

An algorithm 2 describes that the device actively requests the latest global model from the base station. When the training of the device proceeds to the c-th round, the new global model is already sent. The device will continue with the local training after aggregation using the new model.

The algorithm 2 describes an algorithm that the device actively requests sending of the global model. When the device runs the algorithm, all that the base station needs to do is to immediately broadcast the latest global model weight to the device sending the request every time a new global model appears and the device sends the request.

The algorithm 2 has an input that is the global model for the current round and an output that is the local model updated for τ iterations. The remaining parameters are system parameters.

Pseudo codes of the algorithm 2 may be described with reference to:

Input:

| | |
|---|---|
| i: | device number, i E M |
| wₖ: | current global weights |
| k: | current global epoch |
| τ: | The number of local iterations |
| β: | device aggregation weight |
| b: | parameter for calculating adaptive |
| tᵢ^{down}: | time consumed by device i for downloading Global model weights |
| tᵢ^{cp}: | time consumed by device i for local updating |
| ϵ: | device performs local aggregation at the ϵ -th iteration |

Output:

| | |
|---|---|
| w_{i,k}: | updated local model weights in device i |
| κ: | The global epochs when device i starts training |
| 1: | $δ ← \frac{{t}_{i}^{d o w n} τ}{{t}_{i}^{c p}}$ |
| 2: | w_{i,k} (0) ← wₖ |
| 3: | for j ∈ [τ] do |
| 4: | if j == ϵ − δ then |
| 5: | Request for the latest global model weights (whew, knew) asynchronously in |
| | parallel. |
| 6: | end if |
| 7: | if j == ϵ and (wₖ^{new}, k^{new}) is received then |
| 8: | βₖ ← β × (k − κ + 1)^{-b} |
| 9: | Update w_{i,k}(j) ← (1 − βₖ)w_{i,k}(j) + βₖwₖ^{new} |
| 10: | $Update κ ← \frac{{j}_{k} + ( τ - j ) {k}^{new}}{τ}$ |
| 11: | end if |
| 12: | Randomly sample x_{i,d}, y_{i,d} ~ Dⁱ |
| 13: | Update Wik (j + 1) ~ w_{i,k}(j) − η∇F_{i,wk}(w_{i,k} (j), X_{i,a}, Y_{i,a}) |
| 14: | end for |
| 15: | w_{i,k} ← w_{i,k}(τ) |
| 16: | return w_{i,k}, κ |

Hereinafter, the pseudo codes of algorithm 2 will be explained.

Line 1: the time for the base station to sent the new global model, which corresponds to time for several times of local iterations, i.e., δ, is calculated. The time for sending the model is divided by the time of each local iteration (i.e., the model calculation time is divided by τ; in the formula, τ is turned up). This parameter represents how many local iterations ahead to request the base station, so that the local training may be proceeded during sending without wasting time to wait.

Line 2: the device assigns w_{i,k}(O) as the global model weight wₖ of the current round sent by the base station.

Lines 3-11: τ iterations are performed. Before each iteration, lines 4-6 first judge whether j has δ times left before ε, and if it has, then line 5 asynchronously sends the request for additionally sending the global model to the base station. Lines 7-11 judge whether ε has been reached and whether the latest global model has been received at this time, and if they have, the local aggregation is started. Line 8 first calculates βₖ using b and β, which is the local aggregation weight in line 9. Then, line 10 updates κ according to timing of the additional sending of the model, i.e., j, which will be eventually uploaded to the base station along with the trained local model weight to characterize how far behind the device is. Line 12 reads the local data of the device. Line 13 executes the gradient descent operation to update the local model weight.

Line 15: the local training is completed after the τ iterations, and the local model subjected to the τ iterations is assigned to the variable to be transmitted to the base station.

Line 16: the trained local model weight is outputted.

By the algorithm 2, the problem of the obsolescence of the device in FedAsync can be solved. The edge device actively requests for the additional sending of the global model, such that network resources can be saved.

It should be understood that the schematic diagram as shown in FIG. 6 is merely exemplary and not restrictive, and it is extensible. Various obvious changes and/or substitutions may be made by those skilled in the art based on the example of FIG. 6, and the resulting technical solutions still fall within the scope of the embodiments of the present disclosure.

The embodiment of the present disclosure provides a model training control apparatus based on asynchronous federated learning, which is applied to the base station. As shown in FIG. 7, the device includes: a first sending module 701 configured to send the first parameter of the first global model to a plurality of edge devices, the first global model is the initial global model; a first receiving module 702 configured to receive the second parameter of the second global model returned by the first edge device of the plurality of edge devices, the second global model is the global model obtained after the first edge device trains the first global model according to the local data set; and a first control module configured to send the third parameter of the third global model to the second edge device of the plurality of edge devices in the case where the third global model is obtained based on the aggregation of the second global model, the third global model is the latest global model relative to the first global model, and the second edge device is the device which does not complete the training on the first global model.

In some embodiments, the apparatus further includes a first determining module configured to determine the edge device of the plurality of edge devices that does not return the second global model as the second edge device.

In some embodiments, the apparatus further includes a second determining module configured to determine the edge device of the plurality of edge devices that does not return the second global model and sends the model request for requesting the third global model as the second edge device.

In some embodiments, the apparatus further includes a first aggregation module configured to aggregate the first global model and the received second global model to obtain the third global model in response to detecting that the quantity of the second global models reaches the preset threshold.

It should be understood by those skilled in the art that functions of the processing modules in the model training control apparatus based on asynchronous federated learning according to the embodiment of the present disclosure may be appreciated with reference to the foregoing related description of the model training control method based on asynchronous federated learning which is applied to the base station. The processing modules in the model training control apparatus based on asynchronous federated learning according to the embodiment of the present disclosure may be implemented by analog circuits that implement the functions described in the embodiment of the present disclosure, or by running software that implements the functions described in the embodiment of the present disclosure on an electronic device.

The model training control apparatus based on asynchronous federated learning according to the embodiment of the disclosure can improve the efficiency and accuracy of the model training.

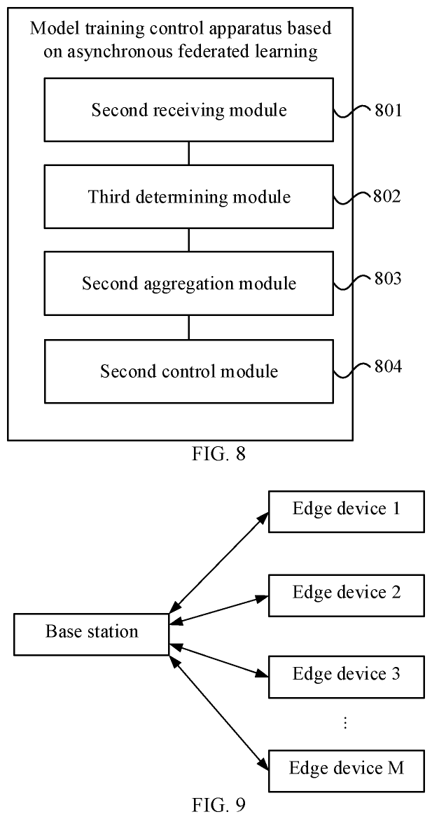

The embodiment of the present disclosure provides a model training control apparatus based on asynchronous federated learning, which is applied to the second edge device. As shown in FIG. 8, the device includes: a second receiving module 801 configured to receive the first parameter of the first global model sent by the base station, the first global model is the initial model received by the second edge device; a third determining module 802 configured to determine the fourth global model during training the first global model based on the local data set, in response to receiving the third parameter of the third global model sent by the base station, the third global model is the latest global model determined by the base station; a second aggregation module 803 configured to aggregate the third global model and the fourth global model to obtain the fifth global model; and a second control module 804 configured to train the fifth global model based on the local data set to obtain the second global model.

In some embodiments, the apparatus further includes a third control module configured to send the model request for requesting the third global model to the base station during training the first global model based on the local data set.

In some embodiments, the apparatus further includes a fourth control module configured to passively receive the third parameter of the third global model sent by the base station during training the first global model based on the local data set.

In some embodiments, the third determining module 802 is configured to determine the latest model obtained from a current training of the second edge device as the fourth global model. The fourth global model is a global model obtained before the training is completed.

It should be understood by those skilled in the art that functions of the processing modules in the model training control apparatus based on asynchronous federated learning according to the embodiment of the present disclosure may be appreciated with reference to the foregoing related description of the model training control method based on asynchronous federated learning. The processing modules in the model training control apparatus based on asynchronous federated learning, which is applied to the edge device, according to the embodiment of the present disclosure may be implemented by analog circuits that implement the functions described in the embodiment of the present disclosure, or by running software that implements the functions described in the embodiment of the present disclosure on an electronic device.

The model training control apparatus based on asynchronous federated learning according to the embodiment of the disclosure can improve the efficiency and accuracy of model training.

An embodiment of the present disclosure provides a model training control system based on asynchronous federated learning. As shown in FIG. 9, the system includes the base station configured to send the first parameter of the first global model, the first global model is the initial global model, and M edge devices, each of which is configured to train the first global model based on its respective local data set; the base station is further configured to determine the third global model in the case where the second parameter of the second global model returned by the first edge device of the M edge devices is received, the third global model is the latest global model relative to the first global model; the M edge devices are further configured to determine the fourth global model during training the first global model in response to receiving the third parameter of the third global model sent by the base station, aggregate the third global model and the fourth global model to obtain the fifth global model, train the fifth global model based on the local data set to obtain the second global model, and return the second parameter of the second global model to the base station, by the second edge device of the M edge devices.

The model training control system based on asynchronous federated learning according to the embodiment of the disclosure can improve the efficiency and accuracy of model training.

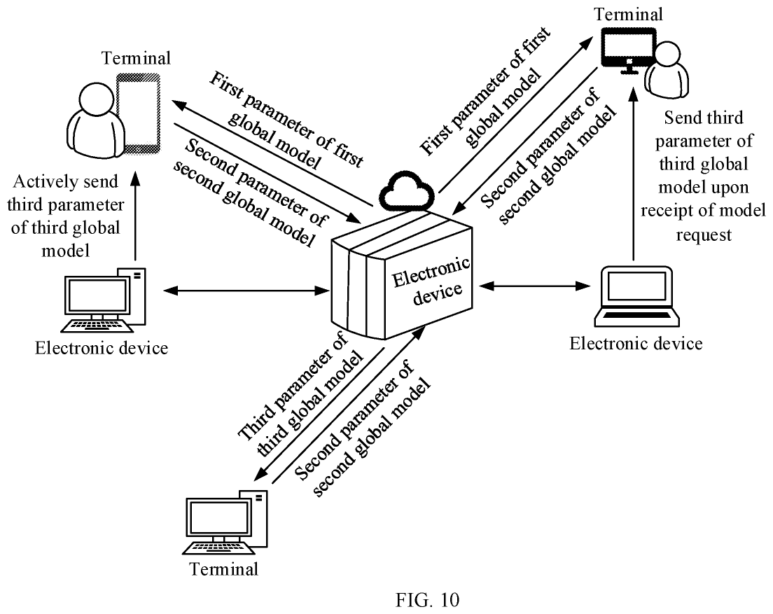

An embodiment of the disclosure further provides a schematic scenario of model training based on asynchronous federated learning. As shown in FIG. 10, an electronic device, such as a cloud server, sends the first parameter of the first global model to terminals; each terminal trains the first global model by using its respective local data set; the electronic device performs aggregation based on the second global model to obtain the third global model in the case where the second parameter of the second global model returned by a part of the terminals is received; and the electronic device sends the third parameter of the third global model to a part of the terminals which does not return the second parameter of the second global model. Herein, the terminals may actively request the third parameter of the third global model or passively receive the third parameter of the third global model.

A quantity of the terminals and the electronic device is not limited in the present disclosure. In practical applications, there may be a plurality of terminals and a plurality of electronic devices.

It should be understood that the schematic diagram shown in FIG. 10 is only exemplary and not restrictive. Various obvious changes and/or substitutions may be made by those skilled in the art based on the example of FIG. 10, and the resulting technical solutions still fall within the scope of the embodiments of the present disclosure.

In the technical solution of the present disclosure, the acquisition, storage and application of the user's personal information involved are all in compliance with provisions of relevant laws and regulations, and do not violate public order and good customs.

According to the embodiment of the present disclosure, the present disclosure also provides an electronic device, a readable storage medium and a computer program product.

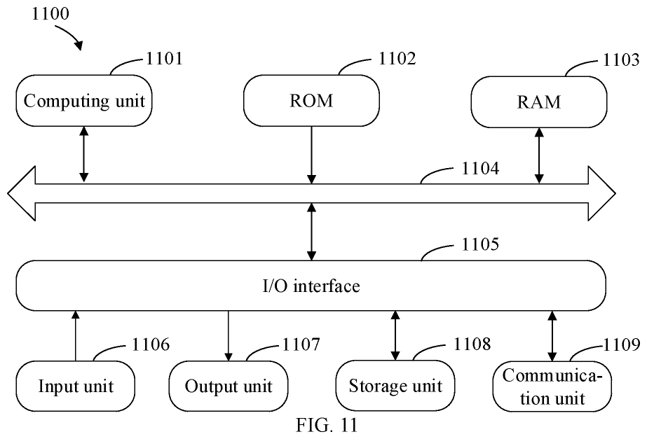

FIG. 11 shows a schematic block diagram of an exemplary electronic device 1100 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 11, the device 1100 includes a computing unit 1101 that may perform various appropriate actions and processes according to a computer program stored in a Read-Only Memory (ROM) 1102 or a computer program loaded from a storage unit 1108 into a Random Access Memory (RAM) 1103. Various programs and data required for an operation of device 1100 may also be stored in the RAM 1103. The computing unit 1101, the ROM 1102 and the RAM 1103 are connected to each other through a bus 1104. The input/output (I/O) interface 1105 is also connected to the bus 1104.

A plurality of components in the device 1100 are connected to the I/O interface 1105, and include an input unit 1106 such as a keyboard, a mouse, or the like; an output unit 1107 such as various types of displays, speakers, or the like; the storage unit 1108 such as a magnetic disk, an optical disk, or the like; and a communication unit 1109 such as a network card, a modem, a wireless communication transceiver, or the like. The communication unit 1109 allows the device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1101 performs various methods and processing described above, such as the above model training control methods based on asynchronous federated learning. For example, in some implementations, the above model training control methods based on asynchronous federated learning may be implemented as a computer software program tangibly contained in a computer-readable medium, such as the storage unit 1108. In some implementations, a part or all of the computer program may be loaded and/or installed on the device 1100 via the ROM 1102 and/or the communication unit 1109. When the computer program is loaded into RAM 1103 and executed by the computing unit 1101, one or more steps of the model training control methods based on asynchronous federated learning described above may be performed. Alternatively, in other implementations, the computing unit 1101 may be configured to perform the above model training control methods based on asynchronous federated learning by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server. It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A model training control method based on asynchronous federated learning, which is applied to a base station, comprising:
sending a first parameter of a first global model to a plurality of edge devices, wherein the first global model is an initial global model;
receiving a second parameter of a second global model returned by a first edge device of the plurality of edge devices, wherein the second global model is a global model obtained after the first edge device trains the first global model according to a local data set; and
sending a third parameter of a third global model to a second edge device of the plurality of edge devices, in a case of the third global model is obtained based on aggregation of at least one second global model, wherein the third global model is a latest global model relative to the first global model, and the second edge device is a device which does not complete training on the first global model.

2. The method of claim 1, further comprising: determining an edge device of the plurality of edge devices that does not return the second global model parameter of the second global model as the second edge device.

3. The method of claim 1, further comprising: determining an edge device of the plurality of edge devices that does not return the second global model parameter of the second global model and sends a model request for requesting the third global model as the second edge device.

4. The method of claim 1, wherein obtaining the third global model based on the aggregation of the second global model, comprises:
aggregating the first global model and second global models whose second parameters have been received to obtain the third global model, in response to detecting that a quantity of the second global models reaches a preset threshold.

5. A model training control method based on asynchronous federated learning, which is applied to a second edge device, comprising:
receiving a first parameter of a first global model sent by a base station, wherein the first global model is an initial model received by the second edge device;
determining a fourth global model during training the first global model based on a local data set, in response to receiving a third parameter of a third global model sent by the base station, wherein the third global model is a latest global model determined by the base station;
aggregating the third global model and the fourth global model to obtain a fifth global model; and
training the fifth global model based on the local data set to obtain a second global model.

6. The method of claim 5, further comprising: sending a model request for requesting the third global model to the base station during training the first global model based on the local data set.

7. The method of claim 5, further comprising: passively receiving, the third parameter of the third global model sent by the base station, during training the first global model based on the local data set.

8. The method of claim 5, wherein determining the fourth global model, comprises:
determining a latest model obtained from a current training of the second edge device as the fourth global model, wherein the fourth global model is a global model obtained before the training on the first global model is completed.

9. A model training control method based on asynchronous federated learning, comprising:
sending, by a base station, a first parameter of a first global model to a plurality of edge devices, wherein the first global model is an initial global model;
training respectively, by the plurality of edge devices, the first global model based on their respective local data sets;
determining, by the base station, a third global model, in a case of a second parameter of a second global model returned by a first edge device of the plurality of edge devices is received, wherein the third global model is a latest global model relative to the first global model;
determining, by a second edge device of the plurality of edge devices, a fourth global model during training the first global model, in response to receiving a third parameter of the third global model sent by the base station;
aggregating, by the second edge device of the plurality of edge devices, the third global model and the fourth global model to obtain a fifth global model;
training, by the second edge device of the plurality of edge devices, the fifth global model based on the local data set to obtain the second global model; and
returning, by the second edge device of the plurality of edge devices, the second parameter of the second global model to the base station.

10. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 1.

11. The electronic device of claim 10, wherein the method further comprises: determining an edge device of the plurality of edge devices that does not return the second global model parameter of the second global model as the second edge device.

12. The electronic device of claim 10, wherein the method further comprises: determining an edge device of the plurality of edge devices that does not return the second global model parameter of the second global model and sends a model request for requesting the third global model as the second edge device.

13. The electronic device of claim 10, wherein obtaining the third global model based on the aggregation of the second global model, comprises:
aggregating the first global model and second global models whose second parameters have been received to obtain the third global model, in response to detecting that a quantity of the second global models reaches a preset threshold.

14. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 5.

15. The electronic device of claim 14, wherein the method further comprises: sending a model request for requesting the third global model to the base station during training the first global model based on the local data set.

16. The electronic device of claim 14, wherein the method further comprises: passively receiving, the third parameter of the third global model sent by the base station, during training the first global model based on the local data set.

17. The electronic device of claim 14, wherein determining the fourth global model, comprises:
determining a latest model obtained from a current training of the second edge device as the fourth global model, wherein the fourth global model is a global model obtained before the training on the first global model is completed.

18. A non-transitory computer-readable storage medium storing a computer instruction thereon, wherein the computer instruction is used to cause a computer to execute the method of claim 1.

19. A non-transitory computer-readable storage medium storing a computer instruction thereon, wherein the computer instruction is used to cause a computer to execute the method of claim 5.

20. The storage medium of claim 19, wherein the method further comprises: sending a model request for requesting the third global model to the base station during training the first global model based on the local data set.
